(19) United States
(12) Patent Application Publication
(10) Pub. No.: US 2010/0240004 A1
(43) Pub. Date: Sep. 23, 2010

(54) CAPSULE FOR MIXING TOGETHER TWO FLOWABLE MATERIALS, AND KITS INCLUDING SUCH CAPSULES, PARTICULARLY USEFUL IN DENTISTRY

(76) Inventor: Moshe ZALSMAN, Ramot-HaShavim (IL)

Correspondence Address: MARTIN D. MOYNIHAN d/b/a PRTSI, INC., P.O. BOX 16446, ARLINGTON, VA, 22215, US

(21) Appl. No.: 12/729,261

(22) Filed: Mar. 23, 2010

(30) Foreign Application Priority Data
Mar. 23, 2009 (IL) 197761

(51) Int. Cl. A61C 5/04

(52) U.S. Cl. 433/90

(57) ABSTRACT

A capsule for mixing together two flowable materials and for applying the resulting mixture to an object, includes: a housing having two compartments for the two flowable materials, a first rupturable separator for separating the two compartments; an applicator at one end of the housing for applying the mixture to the object; a second rupturable separator for separating the second compartment from the applicator; and a plunger at the opposite end of the housing and manually depressible therein to force the flowable material in that compartment to rupture the first separator, to flow into the other compartment, to mix with the flowable material therein, to force the mixture to rupture the second separator, and to exit therefrom via the applicator. The applicator is coupled to the one end of the housing by a quickly-attachable and quickly-detachable connector to enable the capsule to be conveniently used with applicators of different configurations.

### RELATED APPLICATION/S

This application claims the benefit of priority of Israel Patent Application No. 197761 filed Mar. 23, 2009, the contents of which are incorporated by reference as if fully set forth herein.

### FIELD AND BACKGROUND OF THE INVENTION

The present invention relates to capsules for mixing together two flowable materials and for applying the resulting mixture to an object. The invention also relates to a kit including such a capsules and a plurality of applicators of different configurations for selective use with the capsule. The invention is particularly useful in dentistry, for example for applying a dental cement or a dental restoration material to a tooth, and is therefore described below with respect to such an application, but it will be appreciated that the invention could be used in many other applications for applying a mixture of two flowable materials to an object, e.g. for adhesively joining different objects or the like.

Various dental treatments require the application of certain materials, such as dental cement and dental restoration compositions, to a treatment site, which materials or compositions are constituted of a mixture of two flowable materials, such as liquids, powders or pastes. The two materials are included in a capsule provided with an applicator for dispensing the mixture of the two materials.

Such capsules generally comprise a housing including a first compartment for the first flowable material, a second compartment for the second flowable material, a first rupturable separator for separating the first compartment from the second compartment; an applicator at one end of the housing for applying the mixture to the object; a second rupturable separator for separating the second compartment from the applicator; and a plunger at the opposite end of the housing and manually depressible therein to force the first flowable material in the first compartment to rupture the first separator, to flow into the second compartment, to mix with the second flowable material therein, to force the mixture to rupture the second separator, and to exit therefrom via the applicator.

A large number of such capsules have been developed for various purposes for one-time use. Each such capsule generally includes an applicator fixed to the housing of the capsule and of a configuration according to the particular use intended for the mixture supplied by the capsule. Examples of such known dental capsules are described in U.S. Pat. Nos. 5,172,807, 5,871,355, 6,059,570, 6,375,460, 6,422,866, and 6,899,537. In such known capsules, the applicator is generally constructed integrally with, or fixed to, the housing for the material to be dispensed, and therefore a wide range of capsule constructions are required for the various dental treatments that may be involved. Thus, the user must be provided a wide range of disposable capsules according to the various materials to be dispensed, and the various configurations of applicator required to be used for the particular treatment involved.

### OBJECTS AND BRIEF SUMMARY OF THE PRESENT INVENTION

One object of the present invention is to provide a capsule for mixing together and dispensing two flowable materials having advantages in the above respects. Another object of the invention is to provide a kit including one or more such capsules, and particularly including a variety of applicators of different configurations selectively usable with each such capsule according to the particular treatment involved. A still further object of the invention is to provide a capsule, and also a kit including such a capsule, particularly useful in dentistry, e.g., for applying a dental cement or a dental restoration material to a tooth.

According to the present invention, there is provided a capsule for mixing together first and second flowable materials and for applying the resulting mixture to an object, comprising: a housing including a first compartment for the first flowable material, a second compartment for the second flowable material, and a first rupturable separator for separating the first compartment from the second compartment; an applicator at one end of the housing for applying the mixture to the object; a second rupturable separator for separating the second compartment from the applicator; and a plunger at the opposite end of the housing and manually depressible therein to force the first flowable material in the first compartment to rupture the first separator, to flow into the second compartment, to mix with the second flowable material therein, to force the mixture to rupture the second separator, and to exit therefrom via the applicator; characterized in that the applicator is coupled to the one end of the housing by a quickly-attachable and quickly-detachable connector to enable the capsule to be conveniently used with applicators of different configurations.

According to further features in the described preferred embodiment, the quickly-attachable and quickly-detachable connector is a luer connector. Preferably, the quickly-attachable and quickly-detachable connector is a quarter-turn self-locking luer connector.

According to another aspect of the present invention, there is provided a kit including a capsule as described above, and a plurality of applicators of different configurations selectively attachable to, and detachable from, the one end of the housing for selective use according to the particular treatment to be made.

As will be more particularly described below, such a capsule, and kit including such a capsule and a plurality of applicators of different configurations, enable the dentist to select any one of a variety of applicators of different configurations provided in the kit for use with the capsule according to the specific treatment to be made, thereby obviating the need for a capsule for each applicator configurations.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a three-dimensional view illustrating one form of capsule constructed in accordance with the present invention;

FIG. 2 is an enlarged sectional view of the capsule of FIG. 1 and particularly showing the quickly-attachable and detachable applicator included in such capsule;

FIG. 3 is a side elevational view of the housing in the capsule of FIGS. 1 and 2;

FIG. 4 is a bottom view of the housing of FIG. 3;

FIG. 5 is a longitudinal sectional view along line V-V of FIG. 3; and

FIGS. 6, 7 and 8 illustrate applicators of different configurations that may be supplied in kit form with the applicator illustrated in FIGS. 1 and 2, to enable the dentist to select the best applicator appropriate for the particular treatment to be made.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

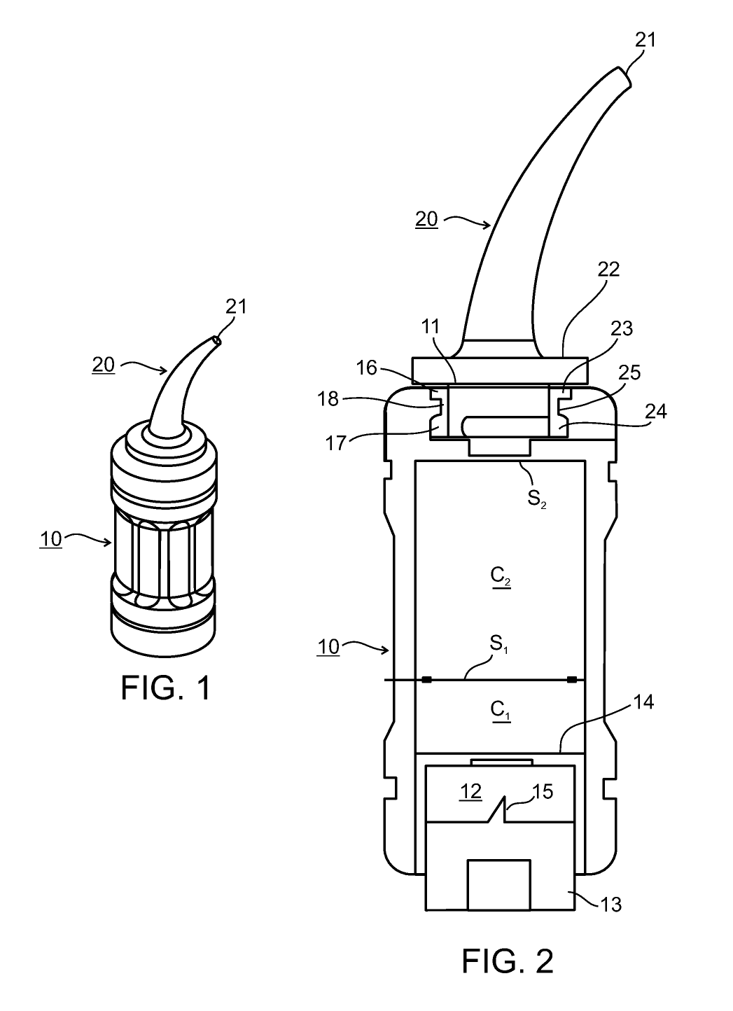

The capsule illustrated in FIGS. 1 and 2 comprises a housing, generally designated 10, for mixing together two flowable materials, and an applicator, generally designated 20, for applying the mixture of the two materials to an object. For example, in a dental treatment, the mixture of the two materials could be applied as a cement or dental restoration composition to a tooth.

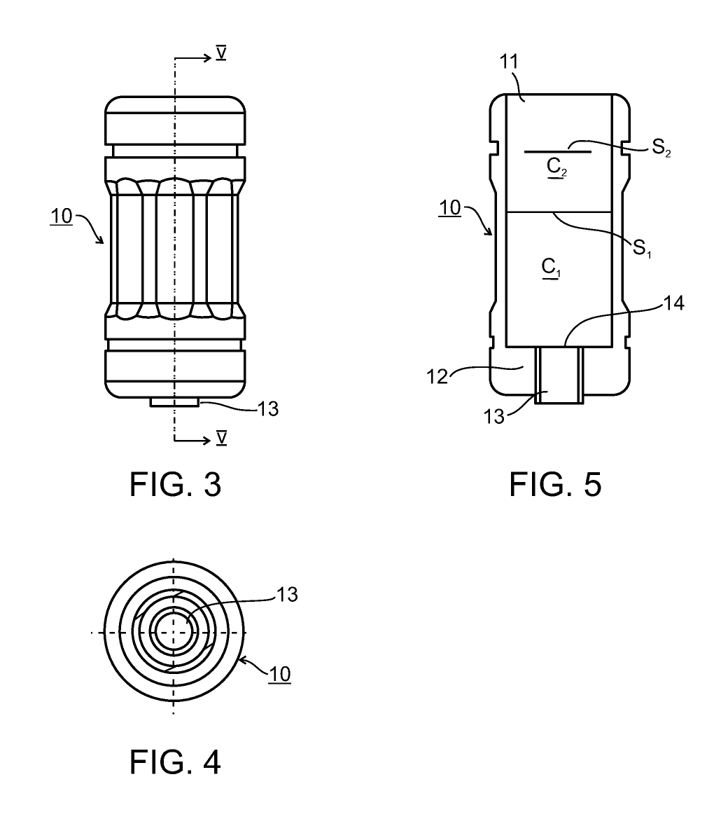

FIGS. 2-5 more particularly illustrate the construction of housing 10. Thus, as shown particularly in FIG. 2, it includes one end formed with a cylindrical socket 11 for receiving the applicator 20, and an opposite end formed with a cylindrical socket 12 for receiving a push-button type plunger 13. Socket 12 is closed by a rupturable wall 14 which is ruptured or pierced by a piercing element 15 carried by plunger 13 upon the depression of the plunger into the interior of housing 10.

The interior of housing 10 is divided into a first compartment C₁ for receiving the first flowable material, and a second compartment C₂ for receiving the second flowable material. Compartment C₁ is separated from compartment C₂ by a rupturable separator S₁; and compartment C₂ is separated from socket 11, receiving the applicator 20, by a second separator S₂, which is also rupturable. For example, separator S₁ and/or separator S₂ could be made of a thin plastic membrane, a thin metal foil, or the like, which is rupturable or piercable upon the application of pressure thereto.

It will thus be seen, particularly from FIG. 2, that when plunger 13 is manually depressed, it first pierces wall 14 of housing 10, forces the flowable material within compartment C₁ to rupture separator S₁ and then to flow into compartment C₂ to mix with the second flowable material therein. At this stage, the capsule may be shaken to more intimately mix the flowable material of compartment of C₁ with that in compartment C₂. Plunger 13 is then depressed further inwardly to force the mixture in compartment C₂ to pierce the second separator S₂ and thereby to flow into applicator 20, through a passageway therethrough, and then discharged from its dispensing tip 21 onto the object, e.g., a tooth, to receive the mixture of materials.

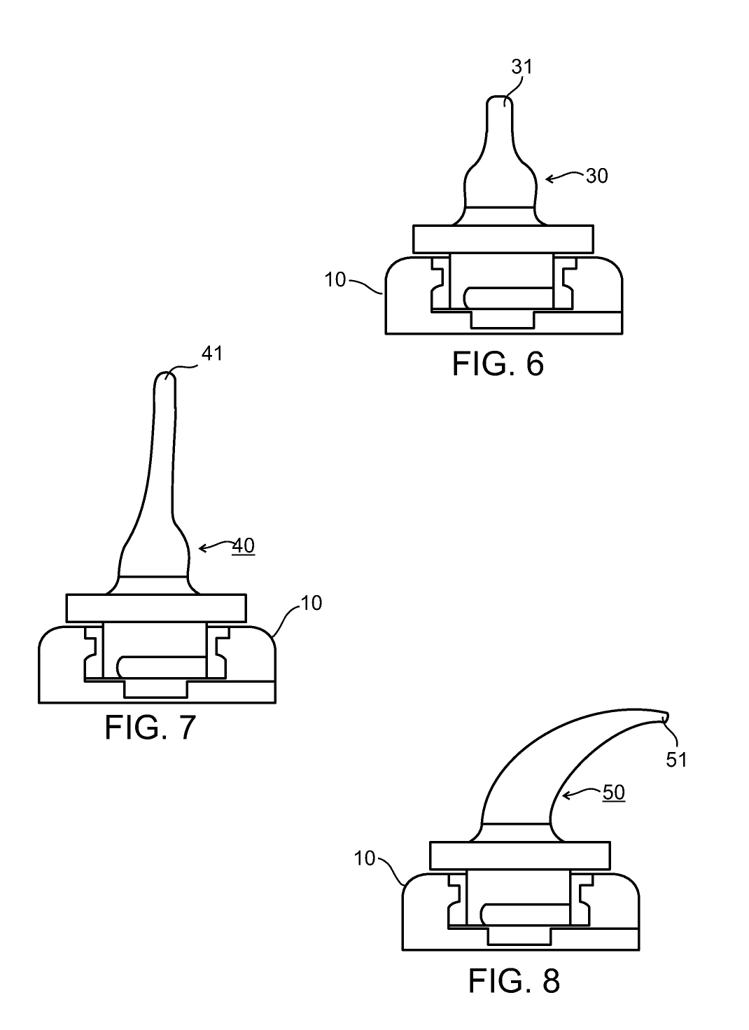

In accordance with the present invention, the applicator 20 is not fixed to the respective end of housing 10, but rather is coupled to that end of the housing by a quickly-attachable and quickly-detachable connector to enable the capsule to be conveniently used with applicators of different configurations, as will be described below with respect to FIGS. 6-8. In the preferred embodiments of the invention illustrated in the drawings, the quickly-attachable and quickly-detachable connector is a luer-type connector integrally formed at the respective ends of the housing 10 and applicator 20. More particularly, the preferred luer connector is a quarter-turn self-locking luer connector structure, wherein the applicator is quickly-attachable and quickly-detachable by a quarter-turn and is self-locking when attached.

As best seen in FIG. 2, the luer-connector structure includes an annular recess 16 formed in the respective end of housing 10, and a second annular recess 17 spaced therefrom by an annular rib 18. Annular rib 18, however, includes a pair of diametrically-opposed cut-outs or slots (not shown) to provide communication between the two annular recesses 16 and 17.

The respective end of applicator 20 is formed with a complementary construction to enable the applicator to be conveniently inserted into the cylindrical socket 11 formed in housing 10, and then to be rotated one-quarter turn for firmly locking the applicator within the socket 11. A one-quarter turn in the opposite direction (or even in the same direction) will unlock applicator 20 from socket 11 to permit the applicator to be detached, e.g. for applying an applicator of a different configuration thereto.

For this purpose, the inner end of applicator 20 includes an annular rib 22 which limits against the outer face of socket 11 in housing 10; another annular rib 23 receivable within annular recess 16 of housing socket 11; and a further annular rib 24 axially spaced from rib 23 and separated therefrom by an annular recess 25 receivable within annular rib 18 of the housing, with rib 24 received within annular recess 17 of the housing. Rib 24, however, is not of a continuous annular configuration, but rather is in the form of two diametrically-opposed projections, such as to be passable through the cut-outs or slots in housing rib 18 into the annular recess 17 of the housing.

It will be appreciated that when applicator 20 is so inserted into the housing socket 11, a quarter-turn of the applicator will align its ribs 24 with unslotted portions of rib 18 of the housing, thereby firmly locking the applicator to the housing, whereas a quarter-turn in the same or opposite direction, will align the diametrically-opposed ribs or projections 24 of the applicator with the slots or cut-outs in housing rib 18, to unlock the applicator from the housing and thereby to permit its convenient removal.

The manner of using the capsule illustrated in FIGS. 1-5 of the drawings will be apparent from the above description. Thus, the capsule can be supplied without the applicator 20, with the two chambers, C₁ and C₂ of the housing filled with the appropriate flowable materials to be mixed and to be dispensed via the applicator 20. When the capsule is to be used, the appropriate applicator 20 may be quickly applied to cylindrical socket 11 at the end of housing 10 and locked therein by a quarter-turn, as described above. Applicator 20 illustrated in FIG. 2 is of a configuration wherein the dispensing nozzle of the applicator decreases in diameter towards its outer dispensing tip 21, and is of an optimum curved configuration for dispensing the mixture of materials to the treatment site. If, however, a different configuration of applicator is desired for a specific treatment, another configuration applicator, such as illustrated in FIGS. 6-8, can be conveniently attached, used, and then detached if desired.

After the capsule has been assembled with the applicator 20 as illustrated in FIG. 2, plunger 13 may be manually pushed inwardly of housing 10, whereupon its piercing element 15 will first rupture wall 14 of the housing, then force the first flowable material within compartment C₁ against separator S₁, rupture that separator, and force the first flowable material into compartment C₂ containing the second flowable material. At this point, if desired, the capsule may be manually or mechanically shaken in order to more uniformly mix the two flowable materials together. Push button 13 may then be depressed further within housing 13 to rupture separator S₂, and to force the mixture from chamber C₂ through the passageway in applicator 20 and out via its dispensing tip 21 onto the surface to receive the mixture.

If at any time before the mixture is to be dispensed, or during the dispensing of the mixture, it is desired to use an applicator of a different configuration in order to best apply the mixture to the receiving site, applicator 20 may be detached by a one-quarter rotation, and another applicator of a more optimum configuration may then be applied by a quarter-turn as described above.

FIGS. 6-8 illustrate, for purposes of example, applicators of different configurations that may be supplied in a kit with each capsule. Thus, FIG. 6 illustrates an applicator, therein generally designated 30, of a straight configuration, rather than a curved configuration, to its outer dispensing tip 31; FIG. 7 illustrates an applicator, generally designated 40, also of a straight configuration but of a longer length to its outer tip 41; and FIG. 8 illustrates an applicator 50 of a curved configuration to its outer tip 51, but more sharply curved and of smaller length than applicator 20 illustrated in FIG. 2. As shown in FIGS. 6-8, each of the applicators includes a luer-type locking structure, as described above with respect to FIG. 2, such that each may be quickly-attachable and quickly-detachable from the housing 10 of the capsule.

While the invention has been described with respect to several preferred embodiments, it will be appreciated that these are set forth merely for purposes of example, and that many other variations, modifications and applications of the invention may be made.

What is claimed is:

1. A capsule for mixing together first and second flowable materials and for applying the resulting mixture to an object, comprising:
a housing including a first compartment for said first flowable material, a second compartment for said second flowable material, and a first rupturable separator for separating said first compartment from said second compartment;
an applicator at one end of said housing for applying said mixture to the object;
a second rupturable separator for separating said second compartment from said applicator;
and a plunger at the opposite end of said housing and manually depressible therein to force said first flowable material in said first compartment to rupture said first separator, to flow into said second compartment, to mix with the second flowable material therein, to force the mixture to rupture said second separator, and to exit therefrom via said applicator;
characterized in that said applicator is coupled to said one end of the housing by a quickly-attachable and quickly-detachable connector to enable the capsule to be conveniently used with applicators of different configurations.

2. The capsule according to claim 1, wherein said quickly-attachable and quickly-detachable connector is a luer connector.

3. The capsule according to claim 1, wherein said quickly-attachable and quickly-detachable connector is a quarter-turn self-locking luer connector.

4. The capsule according to claim 1, wherein said applicator is in the form of a dispensing nozzle having a longitudinal passageway therethrough terminating in a dispensing tip through which said mixture is applied to said object.

5. The capsule according to claim 4, wherein said dispensing nozzle has an outer diameter which decreases toward its dispensing tip.

6. The capsule according to claim 4, wherein said dispensing nozzle is of a curved configuration towards its outer tip.

7. The capsule according to claim 4, wherein said dispensing nozzle is of a straight configuration towards its outer tip.

8. The capsule according to claim 1, wherein said capsule is constructed and dimensioned for mixing together and for applying a dental cement or dental restoration material.

9. A kit including a capsule according to claim 1, and a plurality of applicators of different configurations selectively attachable to and detachable from said one end of the housing.

10. The capsule according to claim 1, wherein said quickly-attachable and quickly-detachable connector is a luer connector.

11. The kit according to claim 9, wherein said quickly-attachable and quickly-detachable connector is a quarter-turn self-locking luer connector.

12. The kit according to claim 9, wherein each of said applicator is in the form of a dispensing nozzle having a longitudinal passageway therethrough terminating in a dispensing tip through which said mixture is applied to said object.

13. The kit according to claim 12, wherein said dispensing nozzle of each applicator has an outer diameter which decreases toward its dispensing tip.

14. The kit according to claim 12, wherein said dispensing nozzle of at least one of said applicators is of a curved configuration towards its outer tip.

15. The kit according to claim 12, wherein said dispensing nozzle of at least one of said applicators is of a straight configuration towards its outer tip.

16. The kit according to claim 12, wherein said capsule is constructed and dimensioned for mixing together and for applying a dental cement or dental restoration material.
